(19) United States
(12) Patent Application Publication
(10) Pub. No.: US 2007/0084362 A1
(43) Pub. Date: Apr. 19, 2007

(54) Printing apparatus, controlling method thereof and manufacturing method of a flat panel display

(76) Inventors: Hoon Kim, Gyeonggi-do (KR); Jung-mi Choi, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/581,646

(22) Filed: Oct. 16, 2006

(30) Foreign Application Priority Data
Oct. 17, 2005 (KR) 2005-0097762

(51) Int. Cl. B41F 15/42; B41L 13/18

(52) U.S. Cl. 101/123

(57) ABSTRACT

A printing apparatus that is capable of facilitating the separation of a mask from a thin film is presented. The separation of the mask from the thin film is important for forming the thin film on a substrate. The printing apparatus includes a table on which the substrate is placed; a mask for screen printing located on the table; an elevation part for moving at least one side of the mask toward and away from the substrate; and a control part for controlling the elevation part. A method of controlling the printing apparatus and a method of manufacturing a flat panel display with the printing apparatus are also disclosed.

### CROSS-REFERENCE TO RELATED APPLICATIONS

This application claims the benefit of Korean Patent Application No. 2005-0097762 filed on Oct. 17, 2005 in the Korean Intellectual Property Office, which is herein incorporated by reference.

### BACKGROUND OF INVENTION

1. Field of Invention

The present invention relates to a printing apparatus, a controlling method thereof, and a manufacturing method of flat panel displays, and more particularly to a printing apparatus, a controlling method thereof, and a manufacturing method of flat panel displays, which are capable of facilitating the separation between a thin film and a mask on the substrate.

2. Description of the Related Art

Today, the role of an OLED (Organic Light Emitting Diode) in the field of a flat panel display industry is becoming increasingly important. This increasing importance of OLED is at least partly due to its advantageous characteristics such as low driving voltage requirement, light weight, thinness, wide viewing angle, and quick response time.

An OLED includes a first substrate provided with organic layers such as an organic emission layer, a hole injecting layer, a hole transporting layer and the like deposited on the substrate. The first and second substrates are positioned in substantially parallel planes. A thin film is interposed between the first substrate and the second substrate for connecting the two substrates and preventing the inflow of moisture or oxygen from the OLED, and such a thin film is coated over the whole surface of the substrate. The thin film may be an organic film that can be formed with a screen printing method.

The screen printing method entails forming a thin film uniformly on the substrate by using a mask. The mask has a mesh part to be placed over the substrate, a masking part framing the mesh part, and a mask frame provided on at least one side of the masking part to maintain a desired level of tension on the mesh part. By moving the squeegee over the substrate while pressing the squeegee against the mesh part, a film material drips or flows into the mesh part. When the squeegee is pressed against the mesh part, the mesh part is stretched to contact a thin film that is being deposited on the substrate. As the squeegee moves on across the mask, the portion of the mesh part that was previously in contact with the thin film becomes separated from the thin film.

As the general size of OLEDs becomes larger, the area of the thin film formed on the substrate also become larger, and the contact area of the mesh part joined to the thin film will also become larger. In this case, because the tension between the mesh part and the mask frame is weaker than the viscous force between the mesh part and the thin film due to the viscosity of the thin film, there is a problem stemming from the slow separation of the mesh part from the thin film, or a separation failure where separated is not achieved.

### SUMMARY OF THE INVENTION

The present invention provides a printing apparatus, a controlling method thereof, and a manufacturing method of flat panel displays for facilitating the separation between a thin film and a mask on the substrate.

Additional features of the invention will be set forth in the description which follows, and in part will be apparent from the description, or may be learned by practice of the invention.

In one aspect, the present invention is a printing apparatus that includes a table on which a substrate is placed; a mask for screen printing located on the table; an elevation part for moving at least one side of the mask toward and away from the substrate; and a control part for controlling the elevation part.

In another aspect, the present invention is a method of controlling a printing apparatus. The method entails: arranging a mask on a substrate, the mask including a mesh part positioned above the substrate, a masking part framing the mesh part, and a mask frame provided on at least one side of the masking part to maintain a tension in the mesh part; placing a film material on a first side of the masking part; positioning a squeegee at the first side of the masking part, wherein the squeegee is capable of moving across the mask; and elevating a second side of the masking part and moving the squeegee across the mask from the first side of the masking part toward the second side of the masking part, wherein the squeegee presses the mesh part toward the substrate as it moves.

In yet another aspect, the present invention is a method of manufacturing a flat panel display. The method entails: providing a substrate; arranging a mask on the substrate, the mask including a mesh part positioned above the substrate, a masking part framing the mesh part, and a mask frame provided on at least one side of the masking part to maintain a tension in the mesh part; and positioning a squeegee at a first side of the masking part on the mask, and elevating a second side of the mask while moving the squeegee from the first side of the masking part toward the second side of the masking part to form a thin film on the area of the substrate that is covered by the mesh part.

It is to be understood that both the foregoing general description and the following detailed description are exemplary and explanatory and are intended to provide further explanation of the invention as claimed.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings, in which:

FIG. 1 is a plan view of a printing apparatus according to an embodiment of the present invention;

FIG. 2 is a cross-sectional view of a printing apparatus taken along the line II-II;

FIG. 3 is a cross-sectional view of a printing apparatus taken along the line III-III;

FIG. 4 is a cross-sectional view showing a state where a mesh part is separated from a thin film;

FIG. 5 is a control block diagram of a printing apparatus according to an embodiment of the present invention;

FIG. 6 is a flow chart illustrating a controlling method of a printing apparatus according to an embodiment of the present invention;

FIG. 7 is a flow chart illustrating a controlling method of a printing apparatus according to another embodiment of the present invention; and

FIG. 8 is a cross-sectional view of an OLED manufactured by a printing apparatus according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to like elements throughout. The embodiments are described below so as to explain the present invention by referring to the figures.

Hereinafter, an embodiment of the present invention will be described in detail with reference to the accompanying drawings.

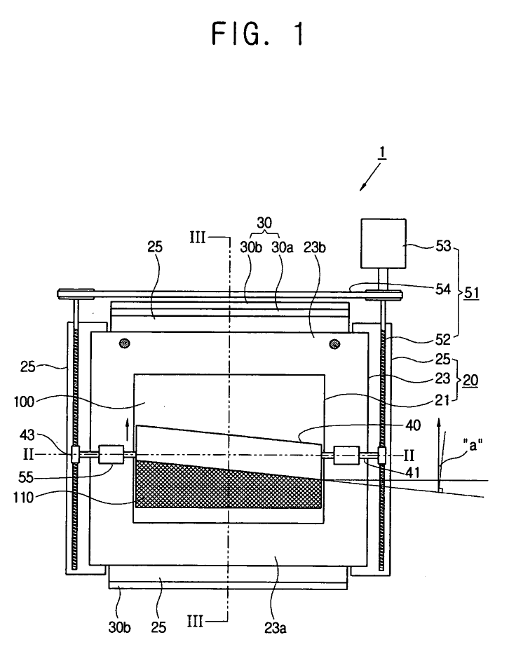

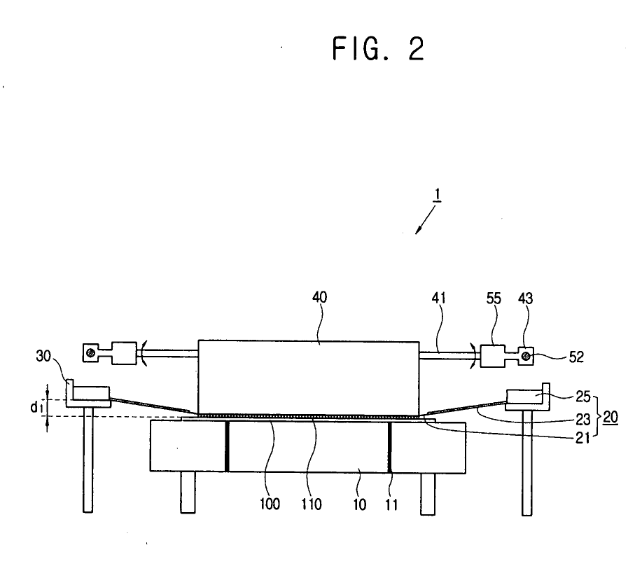

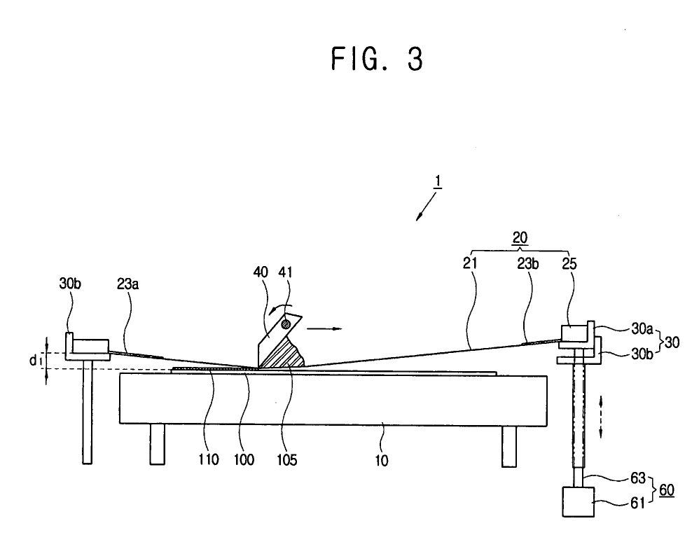

FIG. 1 is a plan view of a printing apparatus according to an embodiment of the present invention, FIG. 2 is a cross-sectional view of a printing apparatus taken along line II-II, and FIG. 3 is a cross-sectional view of a printing apparatus taken along line III-III.

A printing apparatus 1 according to an embodiment of the present invention includes a table 10 on which a substrate 100 is mounted, a mask 20 being located on the table 10, a mask supporting part 30 for supporting at least one side of the mask 20 and separating the mask 20 from the table 10, a squeegee 40 that scans over the mask 20, a first driving motor part 51 for linearly moving the squeegee 40 from one side of the mask 20 to the other side of the mask 20, a second driving motor part 55 for elevating up and down the squeegee 40, an elevation part 60 for moving at least one side of the mask 20 up and down, and a control part 70 for controlling the squeegee driving parts 51 and 55 and the elevation part 60.

The table 10 is a place where the substrate 100, which is an object to be processed, is mounted. At least one mounting pin 11 is provided in the table 10. When the substrate 100 is placed on the table 10 by a robot, the mounting pin 11 in the table 10 is elevated to support the substrate 100 safely. The substrate 100 descends when the mounting pin 11 recedes back down, leaving the substrate 100 to be supported by the table 10.

The mask 20 is located on the table 10. The mask 20 includes a mesh part 21 corresponding to the substrate 100, a masking part 23 surrounding the mesh part 21, and a mask frame 25 provided on at least one side of the masking part 23 to maintain the tension on the mesh part 21. The mesh part 21 is a mesh having openings with a rectangular or trapezoidal shape. The size of the mesh part 21 is less than or equal to that of the substrate 100, and it can be formed in a substantially rectangular shape. The masking part 23 is formed with a flexible material including plastic, and bonded to the periphery of the mesh part 21 to pull the mesh part 21 not to be sagged. Furthermore, the masking part 23 moves up and down along with the mask 20, pressing the squeegee 40 against the mask 20. The mask frame 25 is mounted on the mask supporting part 30, which will be described later, to fix and support the mask 20 not to move when the squeegee 40 is driven. In addition, in the mask frame 25, the masking part 23 and the mesh part 21 are combined with each other, and the mask frame 25 maintains the shape of the mask 20 by pulling the mesh part 21. Furthermore, the squeegee 40 scans across the mask 20 from one side of the masking part 23a toward the other side of the masking part 23b. The mask frame 25 combined with one side of the masking part 23a is fixed, and thus it moves only slightly if at all and does not move up and down as the mask frame 25 combined with the other side of the masking part 23b moves up and down while being supported by the mask supporting parts 30.

The mask supporting parts 30 include two holding parts 30b that are provided along two parallel sides of the table 10. The mask supporting part 30 supports at least a part of the mask frame 25, and fixes the mask 20 so that it does not move when the squeegee 40 is driven. Additionally, the mask fixing part 30 functions to support the mask 20 while spacing the mask 20 apart from the substrate 100 by a predetermined gap. The mask supporting part 30 extends along an edge of the mask frame 25, and the section that is cut perpendicularly to the longest dimension has an L-shaped cross-section, as shown in FIG. 3. The mask supporting part 30 is positioned such that its longest edge is parallel to a moving direction of the squeegee 40, and the mask frame 25 is accommodated and supported by the L-shaped portion. The mask supporting part 30 adjacent to the masking part 23b has a 2-layered structure, which includes a supporting part 30a that prevents the mask 20 from sliding, and the holding part 30b that supports the mask frame 25 when it moves up and down with the elevation part 60. The gap (d1) between the mask 20 and the substrate 100 can be changed according to the size of the substrate 100, but is typically in the range of about 5-30 cm. In case where the substrate 100 has a dimension of 730 mm*920 mm, the gap d1 is about 10 cm.

The squeegee 40 fills a film material 105 into the mesh part 21 while scanning across the mask 20 to form a thin film 110 on the substrate 100. More specifically, the squeegee 40 moves from the masking part 23a toward the masking part 23b and fills the mesh part 21 with the film material 105. Initially, the film material 105 is held at one side of the masking part 23a. As the squeegee 40 moves across the mask 20 being pressed against the mask 20, a thin film 110 having a predetermined thickness is formed on the substrate 100. The mesh part 21 is pressed toward the substrate 100 by the squeegee 40. The mesh part 21, which is pressed on by the squeegee 40, stretches to contact the thin film 110 while being pressed. The stretched portion of the mesh part 21 separates from the thin film 110 after the squeegee 40 passes over it.

However, as the size of the substrate 100 becomes large with increasing display sizes, the area of the thin film 110 formed on the substrate 100 becomes large as well. The contact area of the mesh part 21 that contacts the thin film 110 also becomes large. In particular, since the speed at which the mesh part 21 separates from the thin film is slower than the moving speed of the squeegee 40, the contact area between the mesh part 21 and the thin film 110 becomes larger as screen printing progresses. A case like this is problematic because the tension between the mesh part 21 and the mask frame 25 is weaker than the “sticking” force between the mesh part 21 and the thin film 110 from the thin film's viscosity. If the mesh part 21 takes a long time to separate from the thin film 110, or if the mesh part 21 fails to properly separate from the thin film 110 at all, the uniformity of the thin film 110 will be compromised and the mask 20 could even be damaged.

In order to prevent this problematic situation from arising, the tension between the mesh part 21 and the mask frame 25 is increased. However, there is a limit to how much the force from the tension between the mesh part 21 and the mask frame 25 can be strengthened without changing the basic function of the squeegee 40 scanning across the mask 20 while pressing on the mesh part 21. According to the present invention, the force of the tension between the mesh part 21 and the mask frame 25 is strengthened by lifting up at least one side of the mask 20. More specifically, the attachment force between the mesh part 21 and the thin film 110 that increases as screen printing progresses is reduced by lifting up one side of the mask 20. As a result, the force between the thin film 110 and the mesh part 21 can be appropriate for the tension level between the mesh part 21 and the mask frame 25 and the moving direction and position of the squeegee 40 to achieve a uniform application of the thin film 110.

The portion of the squeegee 40 in contact with the mesh part 21 scans across the mask 20, maintaining a predetermined angle “a” between a direction perpendicular to the long side of the squeegee 40 and a moving direction of the squeegee 40. This is to form a uniform film by depositing a film material 105 in the mesh part 21 uniformly. It will be understood that the angle “a” can be set differently according to the design pattern of the mesh part 21. For example, in an embodiment, the angle “a” may be about 5-50 degrees. The squeegee 40 may be in the form of a stick with the portion that is to contact the mesh part 21 coated or otherwise covered with a soft material such as rubber. The length of the squeegee 40 is equal to or less than the width of the mesh part 21, a driving shaft 41 passes through the squeegee 40, and bearings 43 are provided at opposite ends of the driving shaft 41.

The squeegee driving parts 51 and 55 are configured such that the first driving motor part 51 moves the squeegee 40 straight from one side of the mask 20 to the other side of the mask 20, and the second driving motor part 55 moves the squeegee 40.

In the first driving motor part 51, as shown in FIG. 1, rotary shafts 52 formed with a spinal screw are arranged to be separated by a predetermined distance at opposite sides of the mask 20, and a motor 53 is connected to one rotary shaft 52 to rotate the rotary shaft 52. Furthermore, the other rotary shaft 52, which is not directly connected to the motor 53, is indirectly connected to the motor 53 through a belt 54. Thus, both rotary shafts 52 can rotate at the same speed simultaneously. The rotary shaft 52 is inserted into the bearing 43, and the screw of the rotary shaft 52 is threaded into the bearing 43 to move the squeegee 40 linearly. In other embodiments, the motors 53 may be connected to both rotary shafts 52 to drive them. In some embodiments, the rotary shaft 52 may be formed with a rack that is capable of engaging with pinions provided at both ends of the driving shaft 41 of the squeegee 40 to move the squeegee 40 linearly.

The second driving motor part 55 is located on the driving shaft 41 passing through the squeegee 40, and connected with the squeegee 40 to control the up/down movement of the squeegee 40. The second driving motor part 55 rotates the driving shaft 41 at a predetermined angle to move up or down the squeegee 40. In other words, the squeegee 40 having a plate or stick shape rotates by a predetermined angle such that the bottom surface of the squeegee 40 comes in contact with the mesh part 21, and then moves across the mask 20 by operation of the first driving motor part 51. In other embodiments, the first driving motor part 51 may be configured to move the squeegee 40 up and down without rotation by means of motor, gear, bearing, and the like.

The second driving motor part 55, as shown in the drawing, may be provided at both sides, or may be provided only at one side. The second driving motor part 55 presses a film material 105 on the mesh part 21 toward the substrate 100 to form a thin film 110 on the substrate 100.

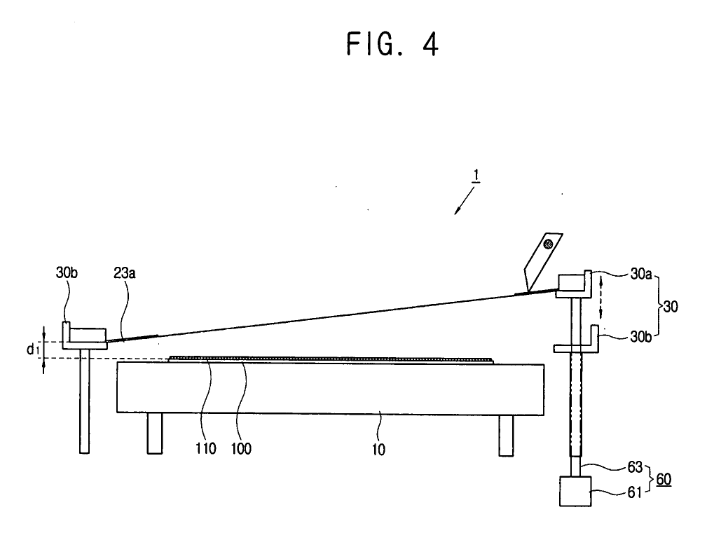

As shown in FIG. 3 and FIG. 4, an elevation part 60 is provided at the bottom of the masking part 23b. The elevation part 60, as an element functioning to lift up one side of the mask 20, includes a driving part 61 for moving one side of the mask 20, and a supporting shaft 63 that moves up and down by driving the driving part 61, for supporting one side of the mask 20. The end of the supporting shaft 63 may support the mask frame 25 that is connected to the masking part 23b. As shown in FIG. 3 and FIG. 4, the supporting shaft 63 may also support a holding part 30b for supporting at least a part of the mask frame 25 to move the mask 20 up and down.

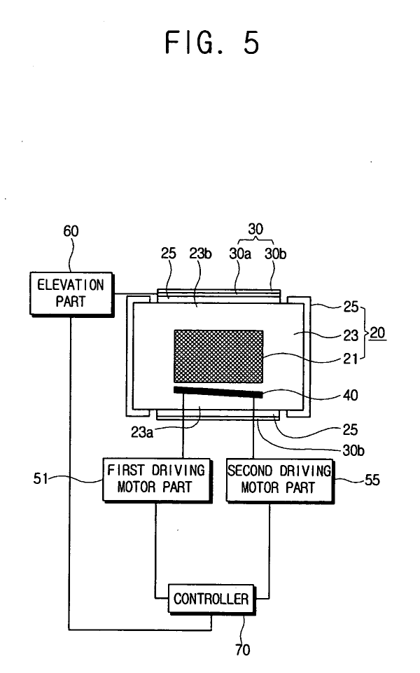

As shown in FIG. 5, in a region that is to one side of the printing apparatus 1, a control part 70 for controlling the squeegee driving parts 51 and 55 and the elevation part 60 is provided. The control part 70 controls the squeegee driving parts 51 and 55 to adjust a linear and upward/downward movement, and also controls the elevation part 60 to lift up one side of the mask 20. The control part 70 controls the elevation part 60 to lift up the mask frame 25, which is combined with one side of the mask 20, more specifically the masking part 23b, at the time the squeegee 40 is scanned across the mask 20. As a result, the connection between the mesh part 21 and the mask frame 25 is strengthened and the separating force between the thin film 110 and the mesh part 21 according to the moving direction and position of the squeegee 40 can be uniformly applied. This way, the separation between the thin film 110 and the mask 20 is performed easily and a uniform thin film 110 is formed on the substrate 100.

Here, the control part 70 may control the first and second driving motor parts 51, 55 in a manner that the up-and-down movement of the mask 20 is synchronized with the driving of the squeegee 40, and the control part 70 may control the elevation part 60 to elevate one side of the mask 20 after the squeegee 40 advances a predetermined distance across the mask 20. Furthermore, the control part 70 may control the elevation part 60 to stop the up-and-down movement of the mask 20 when the squeegee 40 stops progressing on the mesh part 21, and may control the elevation part 60 to stop the elevation movement of the mask 20 while the squeegee 40 is driven. Furthermore, the control part 70 may control the elevation part 60 to move one side of the mask 20 up and down at a constant speed, and may control the elevation part 60 to reduce or increase the elevation speed of the mask 20 as the squeegee 40 advances. In yet other embodiments, the control part 70 may control the elevation part 60 in a manner that the distance by which the mask 20 moves up and down is proportional to the moving distance of the squeegee 40. In such various controlling methods, the separating force between the thin film 110 and the mesh part 21 can be uniformly, adjusted to the moving direction and position of the squeegee 40 in consideration of the size of the thin film 110 to be formed, the viscosity between the mesh part 21 and the thin film 110, and tension between the mesh part 21 and the mask frame 25. The aforementioned various methods can be applied simultaneously or separately and it is possible to find an optimized controlling method for each environment by trial and error.

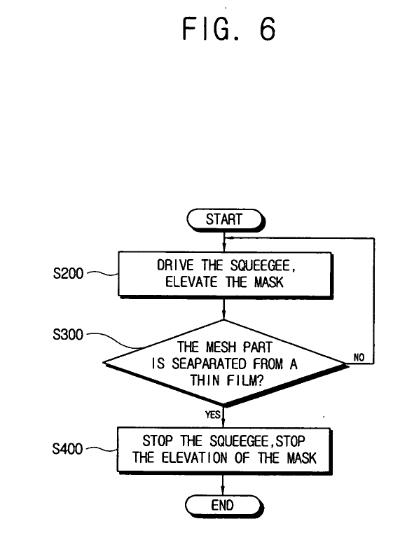

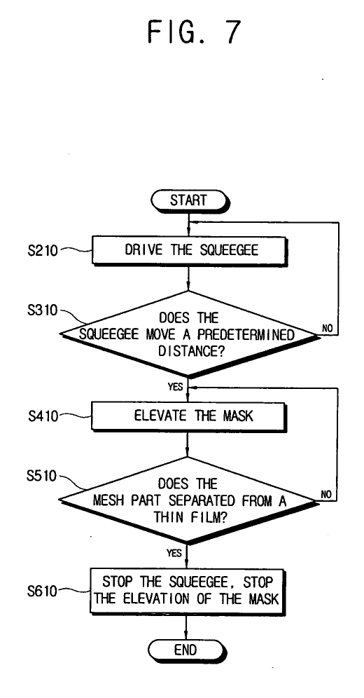

Using the printing apparatus 1 having this configuration, the operation and principle of facilitating the separation between a thin film and a mask will now be described. FIG. 6 a flow chart illustrating a controlling method of a printing apparatus according to an embodiment of the present invention, and FIG. 7 is a flow chart illustrating a controlling method of a printing apparatus according to another embodiment of the present invention. For FIG. 7, only the features that are different from the illustration of FIG. 6 will be described.

The control part 70 drives the squeegee driving parts 51 and 55 to scan the squeegee 40 over the substrate 100 from the masking part 23a toward the masking part 23b, and then controls the elevation part 60 to elevate one side of the mask 20 (operation S200). The mask frame 25 combined with one side of the masking part 23a is fixed, and the mask frame 25 combined with the other side of the masking part 23b is elevated by the elevation part 60. At this time, the squeegee 40 forms a thin film 110 on the substrate 100 while pressing the mesh part 21 toward the substrate 100. Here, the elevation speed of the other side of the mask 20 may be constant, or it may increase or decrease as the squeegee 40 advances.

Subsequently, the control part 70 determines whether the mesh part 21 is separated from the thin film 110 (operation S300). When the mesh part 21 is not completely separated from the thin film 110, the mask 20 can be easily separated from the thin film by further elevating one side of the mask 20 to increase the tension between the mesh part 21 and the mask frame 25. The elevation speed of the mask 20 is controlled in order to uniformly apply a separating force between the thin film 110 and the mesh part 21 while taking into account the moving direction and position of the squeegee 40.

Subsequently, when the mesh part 21 is completely separated from the thin film 110 or the tension between the mesh part 21 and the thin film 110 is sufficient for the separation, the control part 70 controls the elevation part 60 to stop the elevation of the mask 20 and controls the squeegee driving parts 51 and 55 to stop the squeegee 40 (operation S400). In some embodiments, however, it is possible to stop the elevation of the mask 20 after stopping the squeegee 40 first, or the reverse.

According to another embodiment, as shown in FIG. 7, the control part 70 controls the squeegee driving parts 51 and 55 to scan the squeegee 40 over the mask 20 (operation S210).

The control part 70 determines whether the squeegee 40 moves a predetermined distance (operation S310) and lifts up one side of the mask 20 after the squeegee 40 moves the predetermined distance. By adjusting the elevation of the one side of the mask at the proper elevation speed, a desired level of separating force between the thin film 110 and the mesh part 21 is achieved, taking into account the moving direction and position of the squeegee 40. As a result, separation between the thin film 110 and the mask 20 is achieved, and the thin film 110 can be uniformly formed on the substrate 100. The moving distance of the squeegee 40 can be calculated by using the number of revolution of a motor 53 and/or a sensor.

When the squeegee 40 has not traveled the predetermined distance, it will continue to be driven to reach the predetermined distance. When the squeegee 40 reaches the predetermined distance, the control part 70 controls the elevation part 60 to raise one side of the mask 20 (operation S410) . The predetermined distance is a distance that is calculated to achieve the desired separating force between the thin film 110 and the mesh part 21 uniformly while taking into account the moving direction and position of the squeegee 40. The area of the thin film 110 to be formed on the substrate 100, viscosity, and the tension between the mesh part 21 and the mask frame 25 may also be taken into consideration when selecting the predetermined distance. The elevation speed of the other side of the mask 20 may be constant, and it may increase or decrease as the squeegee 40 advances.

The control part 70 determines whether the mesh part 21 is separated from the thin film 110 (operation S510).

In addition, when the mesh part 21 is completely separated from the thin film 110, or the tension between the mesh part 21 and the thin film 110 at the present time is sufficient for separation of the mesh part 21, the control part 70 controls the elevation part 60 to stop the elevation of the mask 20, and controls the squeegee driving parts 51 and 55 to stop the squeegee 40 (operation S610).

Hereinafter, a method of manufacturing flat panel display using the aforementioned printing apparatus 1 will be described. Although this embodiment will be described in the context of an OLED, it should be appreciated that the present invention is not restricted to OLED applications and it can be applied to other flat panel displays such as liquid crystal displays and PDPs. Furthermore, a film or a layer being positioned “on” another film or layer includes not only a case where two films/layers are in contact with each other, but also a case where another film or layer exists between two films/layers.

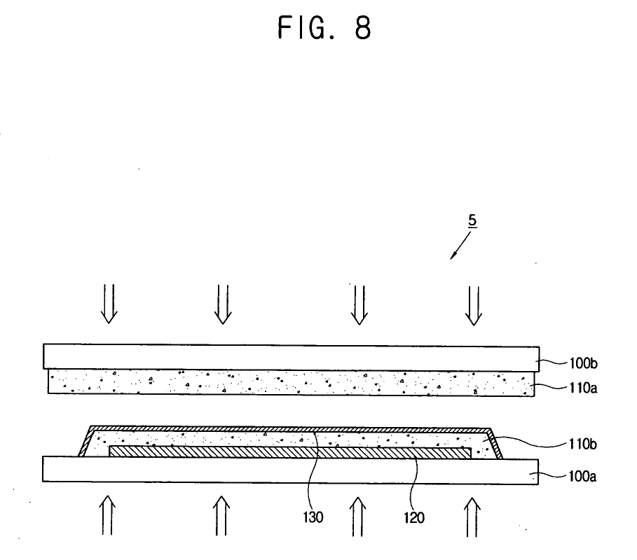

FIG. 8 is a cross-sectional view of an OLED 5 manufactured by a printing apparatus according to the present invention. The OLED 5 is a spontaneous emission type element using an organic material, which emits light in response to electrical signals. A disadvantage of OLED in general is its vulnerability to moisture and oxygen, both of which adversely affects its performance and lifespan. Therefore, a sealing method for effectively preventing oxygen and moisture from infiltrating into the organic material (e.g., an organic emission layer) is adopted.

An OLED 5 according to the embodiment of FIG. 8 includes a first substrate 100a provided with an organic element 120 for displaying an image, a second substrate 100b joined to the first substrate 100a to prevent the inflow of oxygen or moisture into the organic element 120, and thin films 110a and 110b interposed between the first substrate 100a and the second substrate 100b.

The first substrate 100a is a transparent substrate, and may be an organic substrate or a plastic substrate. Although not shown, a barrier layer may be formed on the upper surface of the first substrate 100a, that is, between the organic element 120 and the first substrate 100a. The barrier layer will block oxygen or moisture that can diffuse into the organic element 120 through the first substrate 100a, and may contain SiON, SiO₂, SiNx, Al₂O₃, etc. The barrier layer can be formed by a sputtering method.

The organic element 120 is prepared by using any suitable publicly known method, and it typically includes an organic emission layer, a hole injecting layer, and a hole transport layer. The organic element 120 displays an image corresponding to an image signal that has been received from an information processing device.

The second substrate 100b may be formed with the same material that is used for the first substrate 100a, soda-lime glass substrate, boro-silicate glass substrate, silicate glass substrate, lead glass substrate, or the like. The second substrate 100b may have a thickness of about 0.1-10 mm, and preferably a thickness of about 1-10 mm, to prevent the infiltration of oxygen or moisture into the organic element 120 through the second substrate 100b.

Thin films 110a and 110b are interposed between the first substrate 100a and the second substrate 100b. The thin films 110a and 110b function as the sealing material for preventing the inflow of oxygen or moisture through a space formed between the first substrate 100a and the second substrate 110b. The thin films 110a and 110b even function to join the first and second substrates 100a and 100b to each other. Such thin films 110a and 110b may be an organic or inorganic film, or a composite film having both organic and inorganic materials. Examples of suitable organic material include polyacetylene, polyimide, epoxy resin, etc. while examples of suitable inorganic material include silicon oxide, silicon nitride, magnesium oxide, aluminum oxide, aluminum nitride, titanium oxide, etc. Furthermore, for the thin films 110a and 110b, a radical-based adhesive using a resin such as a thermosetting resin system including urea resin, melamine resin, phenol resin, resorcinol resin, epoxy resin, unsaturated polyester resin, polyurethane resin, acryl resin, etc., a thermoplastic resin system including acetate vinyl resin, ethylene acetate vinyl copolymer resin, acryl resin, cyanoacrylate resin, polyvinyl alcohol resin, polyamide resin, polyolefine resin, thermoplastic polyurethane resin, saturated polyester resin, cellulose, etc., various acrylate including ester acrylate, urethane acrylate, epoxy acrylate, melamine acrylate, acryl-resin acrylate, etc., and urethane polyester; cation-based adhesive using resin such as epoxy, vinyl ethyl, etc.; thiol/N additive resin-based adhesive; and synthetic polymer adhesive using rubber system including chloroprene rubber, nitrile rubber, styrene butadiene rubber, natural rubber, butyl rubber, silicon, etc., and composition system including vinyl phenolic, chloroprene phenolic, nitrile phenolic, nylon phenolic, epoxy phenolic, etc. can be used, although this is not an exhaustive list of suitable materials. A filler may be added to this material of thin films 110a and 110b. Materials that may be used as the filler include but are not limited to inorganic materials such as SiOx, SiON, SiN, etc. or metallic materials such as Ag, Ni, Al, etc. For a method of curing the thin films 110a and 110b, UV curing, visible light curing, UV+ curing, thermal curing, and post curing UV material may be employed.

The embodiment of FIG. 8 includes thin films 110a and 110b formed with an organic material on the first and second substrates 100a, 100b and a protective layer 130 formed from an inorganic material on the thin film 110a. The combination of sealing materials provided herein is not a limitation of the invention, and any suitable combinations may be used. More embodiments will be described in detail in the paragraph that illustrates its sealing method. The thin films 110a and 110b may include thermal or radiation curing materials.

Hereinafter, a sealing method of the OLED using a screen printing method will be described. First, the method will be described in reference to the embodiment of FIG. 8. First, the first substrate 100a provided with the organic element 120 is mounted on the table 10, and a thin film 110a containing an organic material is formed by scanning over the mask 20 with the squeegee 40. The thin film 110a covers the organic element 120. For the thin films 110a and 110b, it is preferable to employ the aforementioned controlling method of a printing apparatus to minimize the chances of nonuniform deposition or defects resulting from mesh-thin film separation failure.

The thin film 100a is semi-cured or cured by applying heat and/or light to it. The reason the thin film 100a is semi-cured or cured in advance will be described below. Gases or toxic substances generated at the time of curing the thin film 110a may infiltrate into the organic element 120 to cause its deterioration. Further, these gases and toxic substances cause image degradation by creating air bubbles that are visibly recognized on the screen. However, because the first and second substrates 100a and 100b are cured before joined with each other, the gases or the like generated at the time of curing are likely to be released into the air instead of being trapped inside the device. Therefore, by performing the curing before combining the two substrates 100a, 100b, is possible to minimize the chances of deterioration of the organic element 120 and the image quality degradation that may appear when the OLED 5 is driven. It is preferable to employ a semi-curing method because the substrates 100a, 100b are easily curable such that the gases or the like generated at the time of curing can be sufficiently released into the air even with only a semi-curing method. Moreover, a protective layer 130 having an inorganic material is formed on the thin film 110a of the first substrate 100a. Alternatively, the protective layer 130 may include a material that chemically reacts with moisture and/or oxygen, such as calcium, barium, calcium oxide, barium oxide, or the like. In another embodiment, moreover, the thin film 110a may further include an absorbent.

A thin film 110b is formed on the second substrate 100b by using a printing apparatus 1 either at the same time as the thin film 110a that is formed on the first substrate 100a or separately at a different time. Here, the thin film 110b may be an organic film but it is still in the uncured state.

When both substrates 100a and 100b are prepared, the two substrates 100a and 100b are joined by being positioned in substantially parallel planes and having the thin films 110a and 110b is cured. The curing process may entail applying heat and/or light while pressing the two thin films 110a, 110b together. Preferably, this curing process is performed in a vacuum chamber, and the pressure that is exerted is about 760 torr. As a result of this curing process, the organic element 120 can be effectively protected from moisture and oxygen. This sealing process is simple, and thus it can be easily applied to the mass production.

According to another embodiment, the thin films 110a and 110b containing organic material are formed on the two substrates 100a and 100b respectively, and then a curing operation is performed with one substrate positioned on top of the other substrate. According to yet another embodiment, a thin film 110a provided on the first substrate 100a is semi-cured or completely cured before a second-stage curing operation is performed with the two substrates 100a and 100b stacked on top of each other.

According to yet another embodiment, the thin films 110a and 110b containing an organic material are formed on the substrates 100a and 100b respectively, and a curing operation is performed after an inorganic film is additionally formed on the thin film 110a of the first substrate 100a. Then, the two substrates 100a and 100b are joined by being stacked on top of each other. In this embodiment, the semi-curing or complete curing operation for the thin film 110a of the first substrate 100a may be omitted.

According to yet another embodiment, an organic film, an inorganic film, and an organic film are stacked, in that order, on the first substrate 100a, and then joined to the second substrate 100b. After the two substrates 100a, 100b are joined, a curing operation may be performed. Alternatively, an organic film on the first substrate 100a is semi-cured or completely cured, and then joined to the second substrate 100b by being stacked on top of each other. A curing operation may be performed to finish the OLED 5.

As described above, according to the present invention, a printing apparatus, a controlling method thereof, and a manufacturing method of flat panel display, which are capable of facilitating the separation between a thin film and a mask on the substrate are provided.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A printing apparatus comprising:
a table on which a substrate is placed;
a mask located on the table;
an elevation part that moves at least one side of the mask toward and away from the substrate; and
a control part that controls the elevation part.

2. The printing apparatus according to claim 1, further comprising a holding part that holds at least one side of the mask, wherein the elevation part supports the holding part to move the mask toward and away from the substrate.

3. The printing apparatus according to claim 2, wherein the mask comprises:
a mesh part positioned above the substrate;
a masking part framing the mesh part; and
a mask frame provided on at least one side of the masking part to apply a desired level of tension in the mesh part,
wherein the holding part supports at least one side of the mask frame.

4. The printing apparatus according to claim 3, further comprising a squeegee that is controlled by the control part to move across the mask, wherein the control part controls the elevation part to move the mask away from the substrate while moving the squeegee across the mask.

5. The printing apparatus according to claim 4, wherein the elevation of the mask is synchronized with the moving of the squeegee.

6. The printing apparatus according to claim 4, wherein the control part controls the elevation part to move the mask away from the substrate after the squeegee advances a predetermined distance.

7. The printing apparatus according to claim 4, wherein the control part controls the elevation part to stop moving the mask away from the substrate while the squeegee is driven across the mask.

8. The printing apparatus according to claim 1, wherein the control part controls the elevation part to move the mask away from the substrate in a direction that is substantially orthogonal to a surface of the substrate at a constant speed.

9. The printing apparatus according to claim 4, wherein the control part controls the elevation part to change the speed at which the mask is moved away from the substrate while the squeegee is moving across the mask.

10. The printing apparatus according to claim 4, wherein the control part controls the elevation part to increase the speed at which the mask is moved away from the substrate while the squeegee is moving across the mask.

11. The printing apparatus according to claim 4, wherein the control part controls the elevation part in a manner that the distance between the mask and the substrate is proportional to the moving distance of the squeegee.

12. The printing apparatus according to claim 4, wherein the mask frame adjacent to one side of the masking part is fixed, and the mask frame adjacent to the other side of the masking part is moved in a direction that is substantially orthogonal to a surface of the substrate while being held by a holding part.

13. The printing apparatus according to claim 2, wherein the elevation part comprises:
a driving part; and
a supporting shaft that is moved by the driving part and supporting the holding part.

14. The printing apparatus according to claim 3, further comprising a mask supporting part supporting at least a part of the mask frame, wherein the mask supporting part has an L-shaped cross-section.

15. The printing apparatus according to claim 14, wherein the mask supporting part comprises a first mask supporting part and a second mask supporting part that is located across the mask from the first mask supporting part, wherein the second mask supporting part has a 2-layered structure and includes the holding part that supports at least a part of the mask frame and a supporting part that supports the holding part.

16. The printing apparatus according to claim 4, wherein the squeegee moves across the mask while maintaining a predetermined angle between a direction that is perpendicular to the longest side of the squeegee and a moving direction of the squeegee.

17. The printing apparatus according to claim 4, wherein the mask is separated from the table by a gap, and the squeegee moves across the mask while depositing a film material into the mesh part and pressing the mesh part toward the substrate.

18. A method of controlling a printing apparatus, the method comprising:
arranging a mask on a substrate, the mask including a mesh part positioned above the substrate, a masking part framing the mesh part, and a mask frame provided on at least one side of the masking part to maintain a tension in the mesh part;
placing a film material on a first side of the masking part;
positioning a squeegee at the first side of the masking part, wherein the squeegee is capable of moving across the mask; and
elevating a second side of the masking part and moving the squeegee across the mask from the first side of the masking part toward the second side of the masking part wherein the squeegee presses the mesh part toward the substrate as it moves.

19. The method of the printing apparatus according to claim 18, wherein the second side of the mask is elevated while the squeegee is moving across the mask.

20. The method of the printing apparatus according to claim 18, wherein the second side of the mask is elevated after the squeegee advances a predetermined distance across the mask.

21. The method according to claim 18, wherein elevation of the second side of the mask is synchronized with the moving of the squeegee.

22. The method according to claim 18, wherein the elevation movement of the second side of the mask is stopped while the squeegee is moving across the mask.

23. The method according to claim 18, wherein the second side of the mask is elevated at constant speed.

24. The method according to claim 18, wherein the elevation speed of the second side of the mask changes as the squeegee advances across the mask.

25. The method according to claim 18, wherein the elevation speed of the second side of the mask increases as the squeegee advances across the mask.

26. The method according to claim 18, wherein the distance by which the second side of the mask is elevated is proportional to the distance the squeegee moved across the mask.

27. A method of manufacturing a flat panel display comprising:
providing a substrate;
arranging a mask on the substrate, the mask including a mesh part positioned above the substrate, a masking part framing the mesh part, and a mask frame provided on at least one side of the masking part to maintain a tension in the mesh part; and
positioning a squeegee at a first side of the masking part on the mask, and elevating a second side of the mask while moving the squeegee from the first side of the masking part toward the second side of the masking part to form a thin film on the area of the substrate that is covered by the mesh part.

28. The method according to claim 27, wherein the substrate is either a first substrate including an organic emission layer or a second substrate that is couplable to the first substrate.

29. The method of according to claim 27, further comprising joining the first substrate to the second substrate and curing the thin film after the thin film is coated on at least one of the first substrate and the second substrate.

30. The method according to claim 27, wherein the first substrate having the thin film and the second substrate are joined by being stacked after performing a partial or complete curing operation on the thin film that is formed on the first substrate.

31. The method according to claim 27, wherein the thin film is cured by at least any one of heat or light.

32. The method according to claim 27, wherein the thin film is any one of an organic film and an inorganic film.
